(19) United States
(12) Patent Application Publication
(10) Pub. No.: US 2021/0309368 A1
(43) Pub. Date: Oct. 7, 2021

(54) HIGH-ALTITUDE JETTISONING AIMING METHOD AND SYSTEM APPLIED TO UNMANNED AERIAL VEHICLE AND STORAGE MEDIUM

(71) Applicant: Shandong Dingfeng Aviation Technology Co., Ltd., Jining City (CN)

(72) Inventor: Yu Tian, Hong Kong SAR (CN)

(21) Appl. No.: 17/220,947

(22) Filed: Apr. 2, 2021

(30) Foreign Application Priority Data
Apr. 2, 2020 (CN) 202010255466.1

(51) Int. Cl. B64D 1/16; A62C 3/02; B64D 47/08; B64C 39/02; G08G 5/00

(52) U.S. Cl. CPC B64D 1/16; A62C 3/025; B64D 47/08; B64C 2201/141; G08G 5/0069; B64C 2201/12; B64C 39/024

(57) ABSTRACT

A high-altitude jettisoning aiming method and system applied to an unmanned aerial vehicle and a storage medium, the method includes collecting a current inclination angle and height information of the unmanned aerial vehicle when the unmanned aerial vehicle is hovering at a fixed point over a target position; calculating a current wind speed and wind direction according to the inclination angle; estimating an offset between an actual jettisoning position of a jettisoned object and the target position according to the wind speed, the wind direction and the height, the offset including an offset orientation and an offset distance; and controlling, according to the offset, the unmanned aerial vehicle to adjust the hovering position such that the actual jettisoning position of the carried object overlaps the target position after the adjustment.

### TECHNICAL FIELD

The present disclosure relates to the technical field of unmanned aerial vehicles, and particularly relates to a high-altitude jettisoning aiming method and system applied to an unmanned aerial vehicle, and a storage medium.

### BACKGROUND

A pilotless aircraft is also called “unmanned aerial vehicle”. It is an unmanned aircraft operated by radio remote control equipment and a self-provided program control device. There is no cockpit on this vehicle, but equipment such as an autopilot and a program control device is installed. Personnel on the ground, a naval vessel or a remote control station of a mother aircraft use radar and other equipment to track, locate, remotely control, and remotely measure the vehicle, and perform digital transmission.

With the popularization of unmanned aerial vehicles, more and more unmanned aerial vehicles are applied to forest fire prevention, emergency rescue, and the like. When an unmanned aerial vehicle is used to perform jettisoning work, a jettisoned object needs to be accurately jettisoned at a target location. For this reason, the following two methods are usually used to achieve this:

1) A ground camera and a wireless image transmission function are used to collect an image and transmit it to the ground in real time. After it is identified that the center of the image is aligned with the target location, a carried object is jettisoned to the target location.

2) According to the known GPS coordinates of the target location, the unmanned aerial vehicle is controlled to fly above the coordinate point, and then jettisons the carried object to the target location.

The above two methods are available in a low-altitude environment, but in a high-altitude environment, the carried object is easily affected by an airflow during falling and thus deviates from the target location. A greater jettisoning height leads to a farther deviation, eventually resulting in failure of a target task. For example, fire extinguishing bombs are jettisoned in firefighting applications such as forest fire prevention. In order to ensure that the fire extinguishing bombs can cover a wider area after blasting in the air, it is required that the jettisoning height for the fire extinguishing bombs must not be less than 100 m. At this time, the fire extinguishing bombs will be greatly affected by the airflow and thus deviate from the target location if they are jettisoned according to the above-mentioned methods, and eventually fail in achieving a good fire extinguishing effect.

### SUMMARY

The present disclosure is directed to provide a high-altitude jettisoning aiming method and system applied to an unmanned aerial vehicle, and a storage medium, so as to overcome the problem that an object is easily affected by an air flow and deviates from a target location during high-altitude jettisoning in the prior art.

In order to achieve the objective, the present disclosure adopts the following technical solutions:

A high-altitude jettisoning aiming method applied to an unmanned aerial vehicle includes the steps of:

collecting a current inclination angle and height information of the unmanned aerial vehicle when the unmanned aerial vehicle is hovering at a fixed point over a target position;

calculating a current wind speed and wind direction according to the inclination angle;

estimating an offset between an actual jettisoning position of a carried object and the target position according to the wind speed, the wind direction and the height, the offset including an offset orientation and an offset distance;

controlling, according to the offset, the unmanned aerial vehicle to adjust the hovering position such that the actual jettisoning position of the carried object overlaps the target position after the adjustment.

Optionally, the method further includes:

acquiring ground image information that covers the target position in real time;

displaying the ground image information, and marking out the target position and the offset in the ground image information.

Optionally, an estimation method for the offset y is: y=a*w2*h where w is the wind speed, h is the height, and a is a coefficient.

A high-altitude jettisoning aiming system applied to an unmanned aerial vehicle includes a sensor unit, a flight control calculation unit, an offset calculation unit, and a position adjustment control unit.

The sensor unit is used for collecting a current inclination angle and height information of the unmanned aerial vehicle when the unmanned aerial vehicle is hovering at a fixed point over a target position;

the flight control calculation unit is used for calculating a current wind speed and wind direction according to the inclination angle;

the offset calculation unit is used for estimating an offset between an actual jettisoning position of a carried object and the target position according to the wind speed, the wind direction and the height, the offset including an offset orientation and an offset distance;

the position adjustment control unit is used for controlling, according to the offset, the unmanned aerial vehicle to adjust the hovering position such that the actual jettisoning position of the carried object overlaps the target position after the adjustment.

Optionally, the system further includes a camera and an image display unit;

the camera is used for acquiring ground image information that covers the target position in real time;

the image display unit is used for displaying the ground image information, and marking out the target position and the offset in the ground image information.

Optionally, the offset calculation unit is specifically used for estimating the offset y according to the formula y=a*w2*h where w is the wind speed, h is the height, and a is a coefficient.

Optionally, the system further includes a photoelectric pod unit used for installing the camera such that the camera is perpendicular to the ground all the time.

A storage medium is provided. The storage medium stores a plurality of instructions; the instructions are suitable for being loaded by a processor to execute the steps in any one of the above-mentioned high-altitude jettisoning aiming method applied to the unmanned aerial vehicle.

Compared with the prior art, the embodiments of the present disclosure has the following beneficial effects.

The embodiments of the present disclosure make use of an angle of attack generated by the unmanned aerial vehicle resisting against wind during hovering to estimate the wind speed and the wind direction, calculate, by means of the wind speed, the wind direction and the height, the offset of the unmanned aerial vehicle generated during falling of the carried object, and perform fine adjustment on the hovering position of the unmanned aerial vehicle according to the offset, thereby causing the carried object to accurately fall to the target position after the adjustment.

### BRIEF DESCRIPTION OF THE DRAWINGS

To describe the embodiments of the present disclosure or the technical solutions in the prior art more clearly, drawings required to be used in the embodiments or the illustration of the prior art will be briefly introduced below. Obviously, the drawings in the illustration below are only some embodiments of the present disclosure. Those ordinarily skilled in the art also can acquire other drawings according to the provided drawings without creative work.

FIG. 1 is a flow diagram of a high-altitude jettisoning aiming system applied to an unmanned aerial vehicle provided by the embodiments of the present disclosure;

FIG. 2 is a diagram of a high-altitude jettisoning aiming example provided by the embodiments of the present disclosure.

### DESCRIPTION OF THE EMBODIMENTS

In order to make those skilled in the art better understand the embodiment solutions of the present disclosure, the technical solutions in the embodiments of the present disclosure will be described clearly and completely below in combination with the drawings in the embodiments of the present invention. Obviously, the embodiments described herein are only part of the embodiments of the present disclosure, not all the embodiments. Based on the embodiments in the present disclosure, all other embodiments obtained by those of ordinary skill in the art without creative work shall fall within the protection scope of the embodiments of the present disclosure.

In the embodiments of the present disclosure, the terms “include” and “have” as well as any of their variations are intended to cover non-exclusive inclusions. For example, processes, methods, systems, products, or devices that include a series of steps or units are not necessarily limited to those steps or units clearly listed below, but may include other steps or units that are not clearly listed or are inherent to these processes, methods, products, or devices.

The core idea of the present disclosure is: making use of an angle of attack generated by the unmanned aerial vehicle resisting against wind during hovering to estimate a wind speed and a wind direction, calculating, by means of the wind speed, the wind direction and a height, an offset of the unmanned aerial vehicle generated during falling of a carried object (such as a fire extinguishing bomb) of the unmanned aerial vehicle, and performing fine adjustment on the hovering position of the unmanned aerial vehicle according to the offset, thereby causing the carried object to accurately fall to a target position after the adjustment.

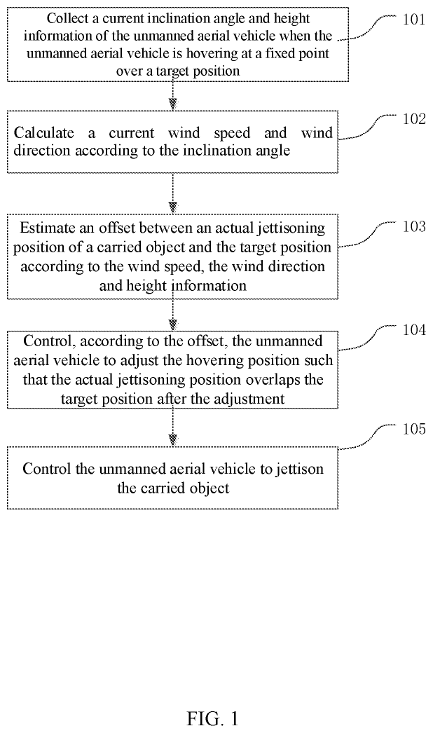

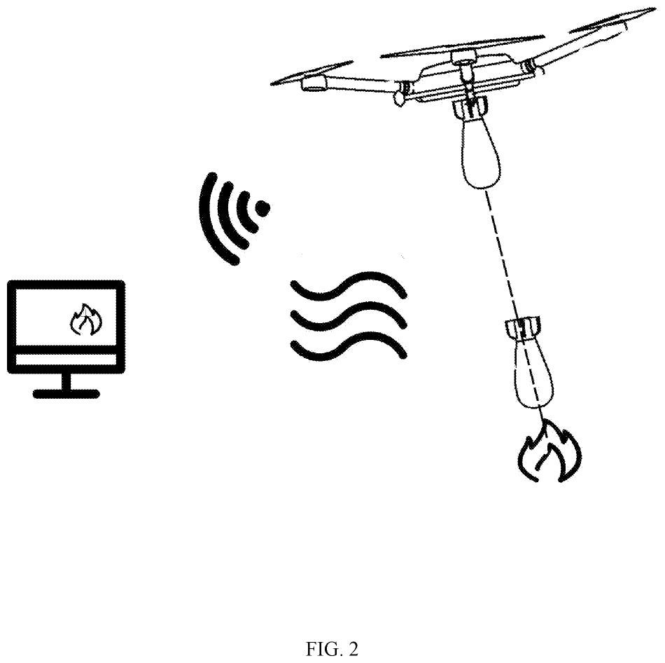

Referring to FIGS. 1 to 2, the embodiments of the present disclosure provide a high-altitude jettisoning aiming system applied to an unmanned aerial vehicle, including the steps:

Step 101, a current inclination angle and height information of the unmanned aerial vehicle are collected when the unmanned aerial vehicle is hovering at a fixed point over a target position.

At this step, the unmanned aerial vehicle can be in the sky over the target position according to the following two methods, including:

According to the first method, a ground camera and a wireless image transmission function are used to collect an image in real time and transmit it to the ground; a path to a target position is planned on the ground according to the image; and the unmanned aerial vehicle is controlled according to this path to fly to the sky over the target position.

According to the second method, the unmanned aerial vehicle is controlled according to acquired GPS coordinates of the target position to fly to the sky over the coordinate point.

When the unmanned aerial vehicle is hovering at a fixed point, if the wind blows by, the unmanned aerial vehicle would form an inclination angle to resist the wind resistance. This inclination angle is in direct proportion to a wind speed, and the direction is consistent with a wind direction. Therefore, a current wind speed and wind direction can be identified according to the collected inclination angle information.

Step 102, the current wind speed and wind direction are calculated according to the inclination angle.

Step 103, an offset between an actual jettisoning position of a carried object and the target position according to the wind speed, the wind direction and the height, the offset including an offset orientation and an offset distance.

For example, an estimation method for the offset y is: y=a*w2*h where w is the wind speed, h is the height, and a is a coefficient.

Step 104, controlling, according to the offset, the unmanned aerial vehicle to adjust the hovering position such that the actual jettisoning position of the carried object overlaps the target position after the adjustment.

Step 105, after the hovering position is finely adjusted, the unmanned aerial vehicle is controlled to jettison the carried object.

It should be noted that the high-altitude jettisoning aiming method of the present embodiment may further includes the steps: acquiring ground image information that covers the target position in real time; and displaying the ground image information, and marking out the target position and the offset in the ground image information. As such, it is conductive for personnel on the ground to carry out quick and accurate fine adjustment.

Another embodiment of the present invention further provides a high-altitude jettisoning aiming system applied to an unmanned aerial vehicle, including a sensor unit, a flight control calculation unit, an offset calculation unit, and a position adjustment control unit.

The sensor unit is used for collecting a current inclination angle and height information of the unmanned aerial vehicle when the unmanned aerial vehicle is hovering at a fixed point over a target position.

The flight control calculation unit is used for calculating a current wind speed and wind direction according to the inclination angle.

The offset calculation unit is used for estimating an offset between an actual jettisoning position of a carried object and the target position according to the wind speed, the wind direction and the height, the offset including an offset orientation and an offset distance.

The position adjustment control unit is used for controlling, according to the offset, the unmanned aerial vehicle to adjust the hovering position such that the actual jettisoning position of the carried object overlaps the target position after the adjustment.

Based on this system, the adverse effect of the airflow can be effectively reduced, and it is ensured that the carried object jettisoned at a high altitude can accurately fall to the target position to achieve a target task.

In addition, the high-altitude jettisoning aiming system of the present embodiment may further include a camera, an image display unit and a photoelectric pod unit.

The camera is used for acquiring ground image information that covers the target position in real time.

The photoelectric pod unit is used for installing the camera such that the camera is perpendicular to the ground all the time to acquire high-quality ground image information for subsequent identification and analysis.

The image display unit is used for displaying the ground image information, and marking out the target position and the offset in the ground image information.

It should be noted that the sensor unit, the flight control calculation unit, the camera and the photoelectric pod unit are installed on the unmanned aerial vehicle; the offset calculation unit, the position adjustment control unit and the image display unit may be arranged in a terminal device (such as a mobile phone and a computer) on the ground; and a user controls a position fine adjustment operation for the unmanned aerial vehicle. In actual application, the offset calculation unit and the position adjustment control unit may also be directly mounted in the unmanned aerial vehicle, and the unmanned aerial vehicle automatically calculates the offset and performs corresponding position fine adjustment. Their realizing principles are exactly the same, so that the present disclosure does not limit this.

One application example is provided below:

Referring to FIG. 2, in the forest fire prevention application, an unmanned aerial vehicle needs to carry fire extinguishing bombs to fly to 100 m over a fire place and jettison the fire extinguishing bombs. The fire extinguishing bombs explode before they are almost in contact with the ground to scatter fire extinguishing powder to a fire source to achieve a fire extinguishing purpose.

Specifically, an unmanned aerial vehicle pilot remotely controls the unmanned aerial vehicle on the ground to fly over the fire place and roughly aim at a fire source through the ground camera. After the unmanned aerial vehicle is stabilized, the flight control calculation unit obtains the height and inclination angle of the unmanned aerial vehicle at this time through the sensor unit, and transmits them to ground station software through a wireless transmission module. The ground station software displays ground image information after calculating, in real time, an offset orientation and a distance during falling of the fire extinguishing bomb, and a cross aiming star is used to mark out an offset position. An operator on the ground finely adjusts the unmanned aerial vehicle at this time to aim at the fire source and then jettison the fire extinguishing bomb. The fire extinguishing bomb at this time can explode at the fire source precisely to extinguish the fire successfully.

Those of ordinary skill in the art can understand that all or part of the steps in the above-mentioned high-altitude jettisoning aiming method applied to the unmanned aerial vehicle can be completed through instructions, or can be completed by controlling related hardware by instructions. The instructions can be stored in a computer-readable storage medium, and loaded and executed by a processor.

For this reason, the embodiments of the present disclosure further provide a storage medium, in which a plurality of instructions are stored. The instructions can be loaded by a processor to execute the steps in the high-altitude jettisoning aiming method applied to the unmanned aerial vehicle provided by the embodiments of the present disclosure.

The storage medium may include a read only memory (ROM), a random access memory (RAM), a magnetic disc or an optical disc.

According to the above, the above embodiments are only used to describe the technical solutions of the present disclosure, and not intended to limit the present disclosure. Although the present disclosure has been described in detail with reference to the foregoing embodiments, those of ordinary skill in the art should understand that they can still modify the technical solutions described in all the foregoing embodiments, or equivalently replace some of the technical features, and these modifications or replacements do not depart the essences of the corresponding technical solutions from the spirit and scope of the technical solutions of all the embodiments of the present disclosure.

What is claimed is:

1. A high-altitude jettisoning aiming method applied to an unmanned aerial vehicle, comprising the steps of:
collecting a current inclination angle and height information of the unmanned aerial vehicle when the unmanned aerial vehicle is hovering at a fixed point over a target position;
calculating a current wind speed and wind direction according to the inclination angle;
estimating an offset between an actual jettisoning position of a carried object and the target position according to the wind speed, the wind direction and the height, the offset including an offset orientation and an offset distance;
controlling, according to the offset, the unmanned aerial vehicle to adjust the hovering position such that the actual jettisoning position of the carried object overlaps the target position after the adjustment.

2. The high-altitude jettisoning aiming method applied to the unmanned aerial vehicle according to claim 1, further comprising:
acquiring ground image information that covers the target position in real time;
displaying the ground image information, and marking out the target position and the offset in the ground image information.

3. The high-altitude jettisoning aiming method applied to the unmanned aerial vehicle according to claim 1, wherein an estimation method for the offset y is: y=a*w2*h, wherein w is the wind speed, h is the height, and a is a coefficient.

4. A high-altitude jettisoning aiming system applied to an unmanned aerial vehicle, comprising a sensor unit, a flight control calculation unit, an offset calculation unit, and a position adjustment control unit;
the sensor unit is used for collecting a current inclination angle and height information of the unmanned aerial vehicle when the unmanned aerial vehicle is hovering at a fixed point over a target position;
the flight control calculation unit is used for calculating a current wind speed and wind direction according to the inclination angle;
the offset calculation unit is used for estimating an offset between an actual j ettisoning position of a carried object and the target position according to the wind speed, the wind direction and the height, the offset including an offset orientation and an offset distance;
the position adjustment control unit is used for controlling, according to the offset, the unmanned aerial vehicle to adjust the hovering position such that the actual jettisoning position of the carried object overlaps the target position after the adjustment.

5. The high-altitude jettisoning aiming system applied to the unmanned aerial vehicle according to claim 4, further comprising: a camera and an image display unit;
the camera is used for acquiring ground image information that covers the target position in real time;
the image display unit is used for displaying the ground image information, and marking out the target position and the offset in the ground image information.

6. The high-altitude jettisoning aiming system applied to the unmanned aerial vehicle according to claim 4, wherein an estimation method for the offset y is: y=a*w2*h, wherein w is the wind speed, h is the height, and a is a coefficient.

7. The high-altitude jettisoning aiming system applied to the unmanned aerial vehicle according to claim 4, further comprising a photoelectric pod unit used for installing the camera such that the camera is perpendicular to the ground all the time.

8. A storage medium, wherein the storage medium stores a plurality of instructions; the instructions are suitable for being loaded by a processor to execute the steps in the high-altitude jettisoning aiming method applied to the unmanned aerial vehicle according to claim 1.

9. A storage medium, wherein the storage medium stores a plurality of instructions; the instructions are suitable for being loaded by a processor to execute the steps in the high-altitude jettisoning aiming method applied to the unmanned aerial vehicle according to claim 2.

10. A storage medium, wherein the storage medium stores a plurality of instructions; the instructions are suitable for being loaded by a processor to execute the steps in the high-altitude jettisoning aiming method applied to the unmanned aerial vehicle according to claim 3.
